(19) United States
(12) Patent Application Publication
(10) Pub. No.: US 2017/0158002 A1
(43) Pub. Date: Jun. 8, 2017

(54) REPAIR PATCH

(71) Applicant: REMA TIP TOP AG, Poing (DE)

(72) Inventors: Christian Casper, Markt Indersdorf (DE); Patric Scheungraber, Pliening (DE); Dieter Thalhammer, Karlsfeld (DE)

(21) Appl. No.: 15/039,304

(22) PCT Filed: Nov. 6, 2014
(86) PCT No.: PCT/EP2014/073909

§ 371 Date: May 25, 2016

(30) Foreign Application Priority Data
Nov. 26, 2013 (DE) 10 2013 224 153.4

(51) Int. Cl. B60C 25/00; B29C 73/10

(52) U.S. Cl. CPC B60C 25/16; B29C 73/10; B29L 2030/00

(57) ABSTRACT

The invention relates to a repair patch for an elastomeric component, in particular for a vehicle tire, to a use of the repair patch and to a method for repairing a vehicle tire. The repair patch has a cover layer 10, a connecting layer 30 for placement on a damaged spot 60 of the elastomeric component 40, and at least one intermediate layer 20, which is arranged between the cover layer and the connecting layer. The repair patch 1 has external dimensions such that a dimensional quotient which is at least formed by means of at least one size parameter of the damaged spot 60 is within a predetermined value range and the number of intermediate layers 20 depends on the at least one size parameter of the damaged spot 60.

The present invention relates to a repair patch (kit patch) for elastomeric components and in particular to a repair patch for vehicle tires as well as to a use of the repair patch and to a method for repairing elastomeric components by means of the repair patch. The effort invested in the repair of the damaged component and in the production of the patch is reduced according to the invention. For example, significantly fewer semi-finished products have to be available for manufacture compared to conventional patches.

Under certain conditions, damaged tires can be repaired in the region of the side wall, shoulder and tread by means of special materials. For this purpose, the damaged area or the damaged spot in the tire is prepared and refilled. In the area of the damaged spot, a repair unit is applied to the inner side of the tire. This repair unit is referred to as a (repair) patch. The patch contains reinforcing materials which bridge the reinforcing materials of the tire, which were destroyed by the damage, thus restoring the usability of the tire.

To date, it has been necessary to produce and have available a large number of repair patches having a plurality of different dimensions to guarantee a permanently operationally reliable repair of the vehicle tire by means of a repair patch with respect to numerous parameters, such as manufacturer-specific factors comprising inter alia tire dimensions, load-bearing capacity, operating pressure, deformation behavior, etc., and in synergy with the employed repair material. The outer patch dimensions required for an operationally reliable repair have been defined to date on the basis of empirical studies and practical examinations and by taking into account valid legal regulations (e.g. ECE R108 and ECE R 109) and could be determined in relation to the dimensions of the damaged spot from so-called damage tables or repair charts.

The drawback of the repair patches known to date is that a large number of repair patches had to be produced with respectively different external dimensions and had to be available in order to provide the repair patches required with respect to an operationally reliable repair substantially for any tire damage, in particular for all sizes of damaged spots of a tire. As a result, a large number of different semi-finished products have to be provided in manufacture and manufacture is quite generally complex and complicated.

Another drawback of the known repair patches is that the user has to use complex repair charts since a large number of different patch types thereof has to be associated with a plurality of different damaged spots.

An object of the present invention is to provide a repair patch for elastomeric components, in particular for vehicle tires, which can be produced with less effort, is less complex as regards the application and offers a high operating reliability. Furthermore, an object of the invention is to provide a corresponding, less complex repair method, in particular when a repair patch is used.

The object is achieved by the invention according to the independent claims. Further preferred developments of the invention are described in the dependent claims.

The repair patch according to the invention for an elastomeric component, in particular for a vehicle tire, can have a cover layer, a connecting layer for placement on a damaged spot of the elastomeric component and at least one intermediate layer. The at least one intermediate layer can be arranged between the cover layer and the connecting layer. The repair patch can have external dimensions such that a dimensional quotient which can be formed at least by means of at least one size parameter of the damaged spot can be within a predetermined value range. The number of intermediate layers can optionally also depend on the at least one size parameter of the damaged spot.

External dimensions of the repair patch here refer e.g. to a length, a diameter, a width and/or an area. The external dimensions according to the invention preferably comprise a length and a width. The dimensional quotient relates in particular at least one external dimension to the size parameter of the damaged spot. The dimensional quotient can preferably have e.g. a length of the patch or a length or width of the largest intermediate layer in the numerator and a length or area of the damaged spot in the denominator.

According to the invention, it is therefore advantageously possible to establish a mathematically comprehensible correlation between the size of the damage and the number as well as the dimensions of the reinforcing layers/intermediate layers in the patch. Thus, material, number and size of the reinforcing layers/intermediate layers used in the patch can be matched with the tire to be repaired and the size of the damage in a simple and less complex way. In the dimensioning of patches, the number and dimensions of reinforcing layers in the patch or of the patch per se are related to the size of the damage and to the tire type.

Furthermore, the production of the patches is less complex due to the coordination of the dimensions of the patch according to the invention and the number of reinforcing layers/intermediate layers with the size of the damage. Thus, production-oriented aspects can be considered in the patches according to the invention to the effect that the least possible number of patches can be produced with the smallest possible number of structural elements. This serves to increase the production accuracy and also to lower the production costs. For example, empirical experience has shown that the usually occurring types or sizes of damage can already be covered by means of e.g. only 4 instead of 11 different patch types and/or dimensions. Patches having identical external dimensions differ according to the invention by the number of reinforcing inserts. As a result, the number of semi-finished products which are required for production can be significantly reduced down to one third of the semi-finished products required for conventional patches.

The application of the patches is considerably simplified already because e.g. repair charts indicating the patches to be inserted depending on the damage size are less complex.

The size parameter of the damaged spot can comprise a (surface) area of the damaged spot, a radius of the damaged spot, a length of the damaged spot in a circumferential direction of the vehicle tire and/or a length of the damaged spot in a radial direction of the vehicle tire.

Furthermore, a dimensional quotient QL can result at least from a width of the repair patch or a width of the largest intermediate layer, which is preferably measured transversely to the fiber direction of the reinforcing fibers of the intermediate layer, in relation to at least the size parameter of a length of the damaged spot in a circumferential direction of the vehicle tire. The predetermined value range can be QL=2-9.

A dimensional quotient QR can result at least from a length of the repair patch or a length of the largest intermediate layer, which is preferably measured along the fiber direction of the reinforcing fibers of the intermediate layer, in relation to at least the size parameter of a length of the damaged spot in a radial direction of the vehicle tire. The predetermined value range can be QR=4-13.

Furthermore, the predetermined value range can be QL=3-9 and QR=4-10 for a damaged spot with a position in a region of a side wall of the vehicle tire. The predetermined value range can be QL=2-5 and QR=4-13 for a damaged spot with a position in the region of the tread of the vehicle tire.

In general terms, the dimensions of the patch used for repair increase with increasing size of the damage. Since the power from the reinforcing materials in the tire is transmitted to the reinforcing materials of the patch via the intermediate rubber, an overlap is required between damage dimension, which is usually referred to as A and R, and length L and width B of the reinforcing layer in the patch. A here refers to the extension of the damage in the circumferential direction of the tire, and B refers to that in the radial direction. The so-called C measure for round damage and the admissible size S damage in the shoulder region can be calculated from the above values.

The above mentioned value ranges indicate values of the dimensional quotient in relation to a position of the damaged spot and with respect to an optimum repair reliability.

Furthermore, the dimensional quotient can reflect at least one value for a size of a surface area of the repair patch in relation to at least one value of a size of the surface area of the damaged spot. This further simplifies the repair process since there is always only one value that is considered, namely in each case the surface area, instead of lengths and widths.

Furthermore, the number of intermediate layers can depend on the size parameter of the damaged spot in such a way that a maximum permissible bulge of the repair patch is not exceeded. A maximum bulge is predetermined by safety regulations which are considered e.g. by predetermined repair charts, and depends in particular on the factors, namely damage size, predetermined inflation pressure of the damaged tire and tire type.

The predefined coordination of the number of intermediate layers with the size of the damaged spot allows a further increased repair reliability. At least one intermediate layer is preferably provided in the case of relatively small damage and at least two intermediate layers are provided in the case of larger damage.

The at least one intermediate layer can have fibers which are substantially structured. The material of the structured fibers can comprise metal, natural fibers, in particular cotton, plastics, glass and/or carbon. The external dimensions of the repair patch can substantially correspond to the external dimensions at least of the at least one intermediate layer. The fibers permit an optimum power transmission across the damaged spot, as a result of which the tire offers an optimum operating reliability after the repair.

Different external dimensions of the repair patch can be predefined with different number of intermediate layers as different repair patch types. The patch types predefined for a concrete case can then be taken, e.g. in a not very complex way, from a repair chart which informs about what damage can be repaired in what tire with what patch.

According to the invention, an application of the tire repair patch according to the invention can be provided for the repair of a vehicle tire which has a damaged spot. Furthermore, a method according to the invention for repairing a vehicle tire by means of a repair patch according to the invention can include the steps of determining the external dimensions of the repair patch and a number of intermediate layers of the repair patch depending on at least one size parameter of a damaged spot of the vehicle tire. The repair patch can be fixedly connected to the vehicle tire in the region of the damaged spot. The external dimensions can be determined in such a way that values of a dimensional quotient can be within a predetermined value range.

The repair method using the repair patch according to the invention can be carried out rapidly and with reduced effort. On account of the reduced number of provided patch types, fewer mistakes can be made when determining the required patch types, as a result of which the reliability of the repair is guaranteed in a better way.

Furthermore, it is possible to determine the external dimensions of the repair patch and the number of intermediate layers by means of a repair chart. The repair chart can predetermine the repair patch type to be selected, in particular the external dimensions and the number of intermediate layers, depending on a position of the damaged spot at the vehicle tire and the at least one size parameter of the damaged spot.

In summary, what applies to the invention is that it has been confirmed on the basis of the insight gained in numerous test stand examinations and practical tests that the patches according to the invention and the associated repair method can simplify the repair of a vehicle tire, can make it more reliable and can simultaneously reduce the production effort for the patches. The invention does not only consider the fact that the patch covers the damage to be advantageous but also the stiffening effect of the multiple intermediate layer for reducing the bulge. This resulted in the definition of repair patches where there are e.g. two versions with different intermediate layer number while the external dimensions remain equal. Due to these empirical findings, it is possible to combine tire sizes in one group and optimize the repair patch program, which results in a clearer repair chart with reduced possible mistakes in the application. The number of the different semi-finished products required for the production of the patch line could be lowered e.g. with respect to conventional patches from 64 to 24.

The invention is described below by way of example with respect to the enclosed, schematic drawings, wherein

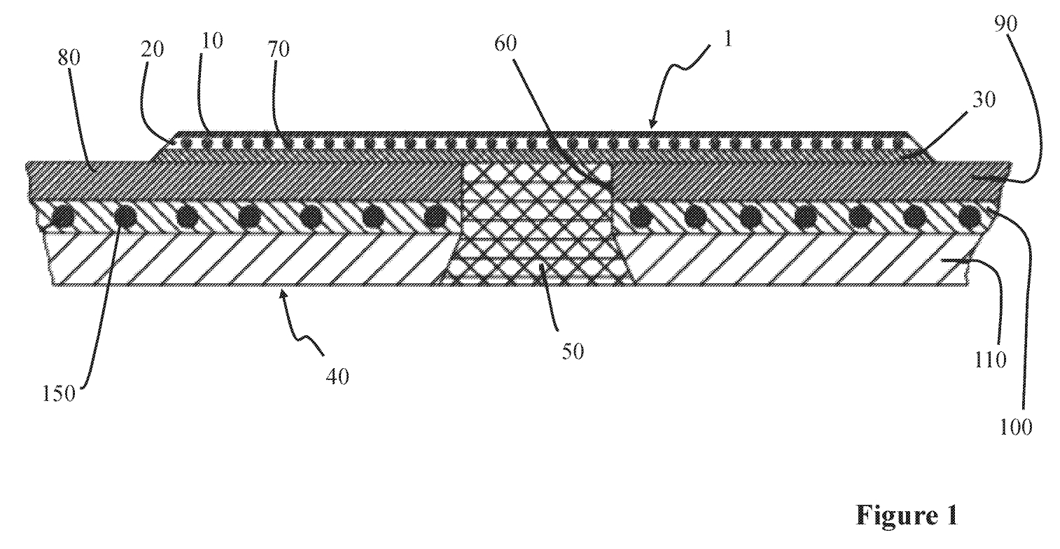

FIG. 1 shows a cross-section through the repair patch and

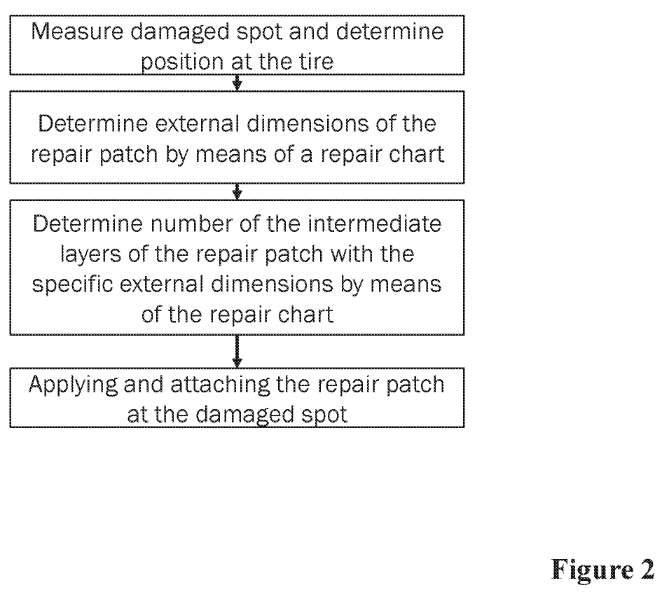

FIG. 2 shows a repair process flow.

In the following, various examples of the present invention are described in detail with reference to the drawings. Equal or similar elements in the drawings are designated with equal reference signs. However, the present invention is not limited to the described design features but also comprises modifications of features of the described examples and the combination of features of various examples on the basis of the scope of protection of the independent claims.

FIG. 1 shows a schematic representation of a repair patch 1 for vehicle tires according to the present invention by way of example. A cover layer 10 is formed on the top side of the repair patch 1. The cover layer 10 can have the function of a protective layer against outer damage of the underlying, in particular power-transmitting, layers, provide the user with information, such as instructions for use or type designations of the repair patch, and/or include graphic and/or decorative elements.

An intermediate layer 20 is formed adjacent to the cover layer 10 and has a plurality of fibrous inserts 70. These inserts 70 are usually arranged across the thickness of the intermediate layer 20 in one or more layers, wherein each individual fiber layer has a structural arrangement of the fibrous inserts 70. The orientation of the individual fiber layers in the intermediate layer 20 can be different with respect to one another. In particular in the case of major damage in the tread or side wall region, these inserts 70 serve to bridge the reinforcing materials cut off in the damaged area.

FIG. 1 shows a repair patch type which has an intermediate layer 20. According to the invention, the number of intermediate layers 20 can be larger, e.g. two to ten intermediate layers 20 can be provided. The number of intermediate layers 20 is determined by using a repair patch type having external dimensions predetermined with respect to the size of the damaged spot and precisely the number of intermediate layers 20.

A connecting layer 30 is formed on the bottom side of the repair patch 1 and is in contact with a wall 80 of the vehicle tire during and after the repair. Furthermore, the connecting layer 30 is in contact with a raw rubber composition 50 before and after a vulcanization of the vehicle tire.

According to the repair of the damaged vehicle tire, the damaged spot of the vehicle tire is roughened so as to remove dust and dirt and to expose an intact layer of the components in the vehicle tire, wherein a substantially conical design is formed for a repair spot or damaged spot 60 in the vehicle tire. Then, the repair spot 60 is filled with the raw rubber composition 50 prior to the vulcanization of the connecting layer 30.

Then, the repair patch 1 preheated to a corresponding joining temperature is placed on the damaged spot 60. With respect to an operationally reliable repair result, the dimensions of the repair patch 1 are determined such that a dimensional quotient Q is within a predetermined value range and the number of intermediate layers 20 can be coordinated therewith.

After the stitching of the repair patch, the repair spot and the repair patch are vulcanized under pressure and at a temperature by means of a suitable device or in the autoclave.

The design of a vehicle tire is here shown by way of example for the side region of a radial truck tire in such a way that the wall 80 of the vehicle tire is formed by the inner liner 90, which is adjoined by a carcass 100, which includes cord 150 in the form of an insert. The side wall rubber 110 of the vehicle tire is located adjacent to the carcass 100.

FIG. 2 also shows a possible process flow for the assembly of the repair patch. For example, the size of the damage is measured in a step. This step can comprise e.g. the detection of the length and/or width of a damage, e.g. of a crack or a hole in the tire. It is preferable to use a repair chart which permits to determine the correct external dimensions and the number of intermediate layers for the present damage with minor effort.

When the external dimensions and the number of intermediate layers have been determined, the assembly of the repair patch 1 can be carried out. For this purpose, patch 1 is fixedly connected by means of the connecting layer 30 to the damaged surface of the component. The fixed connection can be brought about in different ways, wherein it is particularly preferred to form an adhesive connection by means of adhesives and/or to connect the patch by means of a vulcanization process to the rubber of the component to be repaired.

In summary, the invention provides a repair patch or kit patch, which can be handled with little effort, and an associated repair method for elastomeric components, which can be manufactured with less effort and provides the repaired component with a better operational reliability.

1-13. (canceled)

14. A repair patch for an elastomeric component of a vehicle tire, the repair patch comprising:
a cover layer;
a connecting layer for placement on a damaged spot of the elastomeric component; and
at least one intermediate layer arranged between the cover layer and the connecting layer, wherein the repair patch has external dimensions such that a dimensional quotient (Q), which is determined using at least one size parameter of the damaged spot, is within a predetermined value range, and the number of intermediate layers depends on the at least one size parameter of the damaged spot.

15. The repair patch of claim 14 wherein the size parameter of the damaged spot comprises a surface area of the damaged spot, a radius of the damaged spot, a length of the damaged spot in the circumferential direction of the vehicle tire and/or a length of the damaged spot in a radial direction of the vehicle tire.

16. The repair patch of claim 14 wherein:
a dimensional quotient QL results at least from a width of the repair patch in relation to at least the size parameter of a length of the damaged spot in a circumferential direction of the vehicle tire, wherein the predetermined value range of QL is substantially 2≦QL≦9, and a dimensional quotient QR results at least from a length of the repair patch in relation to at least the size parameter of a length of the damaged spot in a radial direction of the vehicle tire, wherein the predetermined value range of QR is substantially 4≦QR≦13.

17. The repair patch of claim 16 wherein:
the predetermined value ranges of QL and QR are substantially 3≦QL≦9 and 4≦QR≦10 for a damaged spot with a position in a region of a side wall of the vehicle tire; and
the predetermined value ranges of QL and QR are substantially 2≦QL≦5 and 4≦QR≦13 for a damaged spot with a position in the region of the tread of the vehicle tire.

18. The repair patch of claim 14 wherein the dimensional quotient (Q) reflects at least one value for a size of a surface area of the repair patch in relation to at least one value of a size of the surface area of the damaged spot.

19. The repair patch of claim 14 wherein the number of intermediate layers depends on the size parameter of the damaged spot so as not to exceed a maximum permissible bulge of the repair patch.

20. The repair patch of claim 14 wherein the at least one intermediate layer substantially has structured fibers.

21. The repair patch of claim 20 wherein the material of the structured fibers comprises metal, natural fibers, in particular cotton, plastics, glass and/or carbon.

22. The repair patch of claim 14 wherein the external dimensions of the repair patch substantially correspond to the external dimensions at least of the at least one intermediate layer.

23. The repair patch of claim 14 wherein different external dimensions of the repair patch are predefined with a different number of intermediate layers as different repair patch types.

24. A method for repairing a vehicle tire using a repair patch, the method comprising:
providing a repair patch comprising:
a cover layer;
a connecting layer for placement on a damaged spot of the vehicle tire; and
at least one intermediate layer arranged between the cover layer and the connecting layer;
determining the external dimensions of the repair patch and the number of intermediate layers of the repair patch based on at least one size parameter of the damaged spot, wherein the external dimensions are determined in such a way that values of a dimensional quotient (Q) of the repair patch are within a predetermined value range; and
fixedly connecting the repair patch to the vehicle tire in the region of the damaged spot.

25. The method of claim 24 wherein the external dimensions of the repair patch and the number of intermediate layers are determined using a repair chart, wherein the repair chart predetermines the repair patch type to be selected, the external dimensions and the number of intermediate layers, dependent on a position of the damaged spot at the vehicle tire and the at least one size parameter of the damaged spot.

26. The method of claim 24 wherein the size parameter of the damaged spot comprises a surface area of the damaged spot, a radius of the damaged spot, a length of the damaged spot in the circumferential direction of the vehicle tire and/or a length of the damaged spot in a radial direction of the vehicle tire.

27. The method of claim 24 wherein:
a dimensional quotient QL results at least from a width of the repair patch in relation to at least the size parameter of a length of the damaged spot in a circumferential direction of the vehicle tire, wherein the predetermined value range of QL is substantially 2≦QL≦9, and
a dimensional quotient QR results at least from a length of the repair patch in relation to at least the size parameter of a length of the damaged spot in a radial direction of the vehicle tire, wherein the predetermined value range of QR is substantially 4≦QR≦13.

28. The method of claim 27 wherein:
the predetermined value ranges of QL and QR are substantially 3≦QL≦9 and 4≦QR≦10 for a damaged spot with a position in a region of a side wall of the vehicle tire; and
the predetermined value ranges of QL and QR are substantially 2≦QL≦5 and 4≦QR≦13 for a damaged spot with a position in the region of the tread of the vehicle tire.

29. The method of claim 24 wherein the dimensional quotient (Q) reflects at least one value for a size of a surface area of the repair patch in relation to at least one value of a size of the surface area of the damaged spot.

30. The method of claim 24 wherein the number of intermediate layers depends on the size parameter of the damaged spot so as not to exceed a maximum permissible bulge of the repair patch.

31. The method of claim 24 wherein the at least one intermediate layer substantially has structured fibers.

32. The method of claim 31 wherein the material of the structured fibers comprises metal, natural fibers, in particular cotton, plastics, glass and/or carbon.

33. The method of claim 24 wherein the external dimensions of the repair patch substantially correspond to the external dimensions at least of the at least one intermediate layer.

34. The method of claim 24 wherein different external dimensions of the repair patch are predefined with a different number of intermediate layers as different repair patch types.
